(19) United States
(12) Patent Application Publication
(10) Pub. No.: US 2005/0098609 A1
(43) Pub. Date: May 12, 2005

(54) Transient eutectic phase process for ceramic-metal bonding metallization and compositing

(76) Inventors: Victor A Greenhut, Piscataway, NJ (US); Thomas R Chapman, Corning, NY (US)

Correspondence Address: DUANE MORRIS LLP, PO BOX 5203, PRINCETON, NJ, 08543-5203, US

(21) Appl. No.: 10/467,006

(22) PCT Filed: Jan. 14, 2002
(86) PCT No.: PCT/US02/01050

Related U.S. Application Data
(60) Provisional application No. 60/265,878, filed on Feb. 5, 2001.

(51) Int. Cl. B23K 31/02

(52) U.S. Cl. 228/122.1

(57) ABSTRACT

A method for directly joining ceramics (10) and metals (12). The method involves forming a structure having a ceramic component (10), a more refractory metallic component and a less refractory metallic-material-based interlayer (14) disposed between the ceramic component (10) and the metallic component (12); adding a eutectic forming reactant to the metallic interlayer (14); and heating the structure to approximately a eutectic melting temperature of the reactant and the interlayer to form a metallic-material-based eutectic liquid that interacts with the metallic component to form a bond that directly joins the ceramic and metallic components to one another.

### FIELD OF THE INVENTION

The present invention relates to ceramic-metal bonding, ceramic metallization and ceramic-metal compositing and more particularly, to a method that utilizes a low temperature transient metallic-material-based eutectic liquid to directly bond ceramic bulk materials and coatings to metals and visa versa, metallize ceramics and produce ceramic-metal composites in a wide variety of configurations.

### BACKGROUND OF THE INVENTION

No single material is available today that possesses all of the material properties to meet the stringent demands of many traditional and advanced applications. Metals, although ductile with high thermal and electrical conductivity, often cannot withstand high temperatures or corrosion, and expand significantly with increasing temperature. An alternative to metals are ceramics, which are brittle insulators. Ceramics are refractory, hard, and wear-resistant, with excellent hot properties and relatively low thermal expansion. By joining ceramics and metals, composite components that may employ the desired properties of each material, can be manufactured to meet these increasing requirements. The technology required to bond these dissimilar materials effectively, reliably, and economically is in high demand.

Several joining technologies, which utilize interfacial methods, have proven effective for bonding ceramics and metals, but their high processing costs limit their penetration of some potential markets. Direct joining or bonding requires few processing steps and therefore significantly reduces cost and eliminates interfacial joining material that may compromise properties. It can also provide property advantages such as hermeticity, stress transfer, stress reduction, continuity of strain, electrical response, interfacial properties, and mechanical interlocking.

Therefore, an effective method of directly joining or bonding ceramics and metals is needed.

### SUMMARY OF THE INVENTION

A method is described herein for directly joining ceramics and metals. The method comprises forming a structure having a ceramic component, a metallic component and a metallic interlayer disposed between the ceramic component and the metallic component, the metallic interlayer being less refractory than the metallic component by means of a eutectic melt formed by adding a eutectic-forming reactant, such as a gas, an oxide of the metallic material of the interlayer or other compound, to the metallic interlayer (this is commonly termed gas-metal eutectic); and heating the structure to approximately a eutectic melting temperature of the eutectic-based interlayer system to form a metallic-material-based eutectic liquid that interacts with the metallic component to form a bond that directly joins the ceramic and metallic components to one another. The components may be bulk parts, metallization, ceramic coating layers, or compositing materials

### BRIEF DESCRIPTION OF THE DRAWINGS

FIGS. 1-4 are sectional views through a metal/metal eutectic-forming interlayer/ceramic system which illustrate the method of the present invention.

### DETAILED DESCRIPTION

The present invention is a method of directly joining or bonding ceramics and metals (the terms “metal” and “metallic” being used herein to encompass metals, metal alloys, intermetallics, materials containing a substantial amount of metallically bonded materials, and any combination or combinations thereof) using a transient, low-temperature, metallic-material-based eutectic liquid or melt, i.e., where the metallic-material-based eutectic liquid “disappears” via solidification into a desired alloy or other metallically bonded material. To be consistent with current terminology and the illustrative embodiment to be described further on, the metallic-material-based eutectic liquid or melt will also be referred to hereinafter as “gas-metal eutectic.” It should be understood, however, that the eutectic constituents may also be provided by a liquid or solid in contact with an interlayer formed of a metallic material (metallic interlayer). The transient, low-temperature, metallic-material-based eutectic liquid is generated in the present invention by combining a eutectic-forming reactant, such as a gas, an oxide layer or another compound, with the metallic interlayer having a eutectic melting temperature which is lower than that of the metallic material of the interlayer of the subject ceramic-metal system. The method is useful for but not limited to: direct bonding ceramic coatings to metals, direct bonding metal coatings to ceramics, producing a metallic joint between two or more ceramic components for bonding ceramics to ceramics, metallizing ceramics and producing ceramic-metal composites. According to the principles of the present invention, the low temperature, metallic-material-based eutectic melt or liquid is made transient (by solidification) through interaction with a more refractory metallic component, that in some embodiments is more active than the metallic material of the eutectic liquid. It should be noted that the more active metallic component, which is nickel in the exemplary embodiment described herein, improves the bond and enhances the bond quality. The metallic-material-based eutectic liquid provides, when the metallic component is directly joined with a ceramic component, a ceramic-metal bond or joint having good wetting, high strength, a broad process window (relative to conventional gas-metal eutectic bonds), high thermal stability, and controlled thermo-elastic stress. The metallic-material-based eutectic liquid of the present invention also enables the transportation of a more active metal species to the ceramic interface to further improve adherence.

For illustrative purposes only, the method of the present invention will now be described with application to a nickel/oxygen-copper/alumina system. One of ordinary skill in the art will of course recognize that the method of the invention is applicable to other metal/metallic-material-based eutectic/ceramic systems. The metallic-material-based eutectic interlayer is formed by interaction of the metallic interlayer with a gas, liquid or solid which promotes formation of a low-melting eutectic.

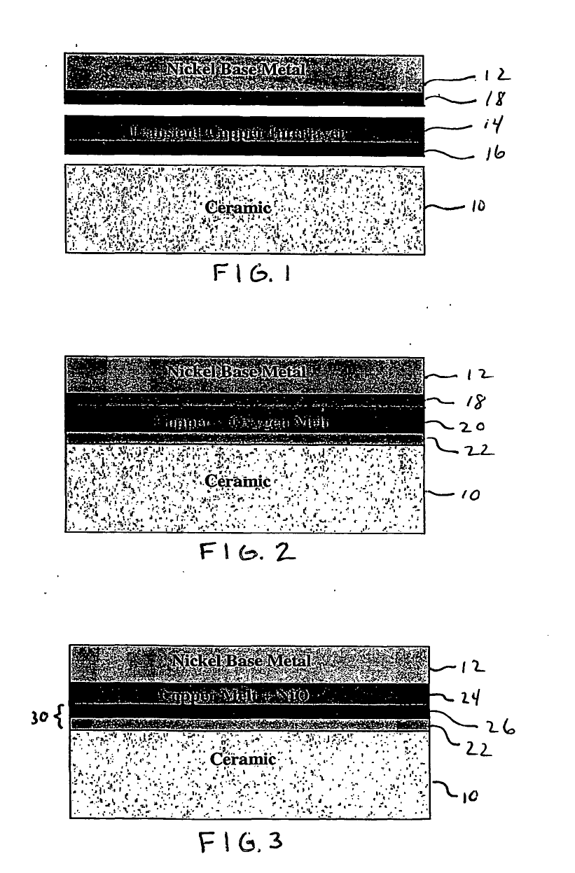

Referring now to the drawings and initially to FIG. 1, an exemplary embodiment of the method of the present invention may commence with the fabrication of a multilayer structure that includes a ceramic component layer 10, a metallic component layer 12, and a metallic interlayer 14. The metallic component layer 12 may be more active than the metallic interlayer 14 and is, therefore, referred to hereinafter as active metal component layer 12. The metallic interlayer 14, when combined with appropriate specie from a eutectic forming reactant, such as a gas, liquid or solid, has a lower melting temperature than the metallic interlayer 14 or the active metal component layer 12. In the exemplary metal/oxygen-copper/alumina system illustrated in FIGS. 1-4, the ceramic component layer 10 comprises alumina, the active metal component layer 12 comprises nickel, and the metallic interlayer 14 comprises copper, preoxidized copper or copper containing dispersed copper oxide. Each metallic layer in the structure may be provided as a solid using one or more metal foils, a metal powder or a metal paste, or can be deposited in solution, i.e., plated, evaporated, or sputtered on either material surface prior to joining.

Referring still to FIG. 1, a barrier layer 18 is formed on the active metal component layer 12 to minimize competitive interaction of reactants (oxygen in the illustrated system) with the active metal component layer 12, which allows the gas-metal eutectic liquid to form and wet the ceramic prior to reaction with the active metal component layer 12. In the system illustrated in FIGS. 1-4, the barrier layer 18 may comprise nickel oxide.

The metallic interlayer 14 should be sufficiently thick, i.e., greater than 10 microns in the case of copper, to form an adequate amount of gas-metal eutectic liquid phase on heating. While a thinner metallic interlayer 14 (less than 10 microns in the case of copper) may be used, the heating rate required to achieve melting before the active metal component layer 12 and the metallic interlayer 14 form a metallic alloy or intermetallic may not be possible or practical. In addition, the small amount of gas-metal liquid formed from a thin metallic interlayer 14 requires polished surfaces and applied pressure to maintain intimate contact. Sufficiently thick metallic interlayers 14 do not require polished surfaces or pressure because the gas-metal eutectic liquid provides wetting, reaction, and adherence to the ceramic component layer 10. Accordingly, there is substantially no need for pressure and conformance fixturing beyond that required for holding parts together. Moreover, the gas-metal eutectic liquid penetrates roughness or keyholes for enhanced mechanical bonding.

Additions of the gas are added to the metallic interlayer 14 of the multilayer structure. In the nickel/oxygen-copper/alumina system application, instead of using oxygen or oxygen containing gas mixtures, the oxygen additions may be accomplished by pre-oxidizing the metallic interlayer 14 prior to eutectic melting/bonding, thereby forming a copper oxide layer 16 on the copper interlayer 14. Alternatively, (or in addition to the copper oxide layer 16), gas additions may be accomplished in-situ, i.e., gas may be added during eutectic melting/bonding.

Eutectic melting/bonding is achieved by heating the multilayer structure in a suitable oven to at least the eutectic melting temperature (copper-oxygen at 1065° C.) of the metallic interlayer 14 and the gas or other interlayer reactant, but below the melting point of the active metal layer 12 (nickel at 1452° C.), in an atmosphere of limited oxygen (reactant) fugacity (inert, controlled oxygen partial pressure, or vacuum). The level of oxygen (reactant) should be carefully controlled to facilitate formation of the gas-metal eutectic and to prevent the formation of an excessively thick (several microns thick) reaction layer to be described further on.

As the temperature is raised above the eutectic melting point, the metal interlayer 14 uniformly forms a transient, low-temperature, gas-metal eutectic melt or liquid 20 at the interface between the active metal component layer 12 or active metal component barrier layer 18 and the ceramic component layer 10 as shown in FIG. 2. There may be excess interlayer metal (copper) or reactant (oxygen) relative to the exact eutectic composition in which case the temperature must be raised above the liquidous temperature. The gas-metal (copper-oxygen) eutectic melt or liquid 20 wets the component layers 10 and 12 or 18, initiates contact therebetween, and begins to react with the ceramic component layer 10 to form a first reaction layer 22 thereon, which in the illustrated system comprises copper-aluminate. Because substantially the entire metallic interlayer 14 is melted by raising the temperature above the interlayer metal melting temperature (copper at 1083° C.), the processing window is wider than conventional gas-metal eutectic bonding processes in terms of temperature, atmosphere, and time.

As the multilayer structure is held above the eutectic melting temperature, the gas-metal eutectic liquid 20 dissolves or consumes the optional barrier layer (nickel oxide) 18, and ultimately, part of the active metal component layer 12. The barrier layer 18, thus, controls the rate of dissolution or diffusion of the active metal component layer 12 into the gas-metal eutectic melt or liquid interlayer 20. The dissolved metallic material is transported toward the ceramic component layer interface where it reacts to form a second reaction layer or replacement reaction layer 26, which comprises nickel-aluminate (NiAl₂O₄) spinel in the illustrated system, superimposed on or replacing the previously formed first reaction layer 22, which together form a refractory bond phase joint 30 as shown in FIG. 3.

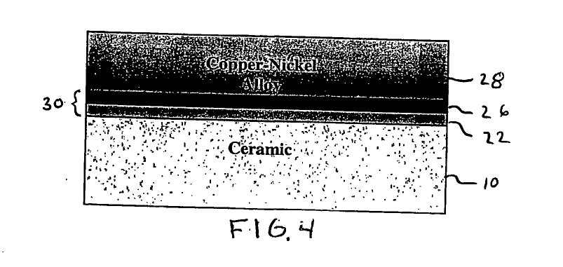

As the active metal (nickel) dissolves or diffuses into the interfacial gas-metal eutectic liquid 20 (copper-oxygen) at temperature, the interlayer liquid composition changes (copper-nickel-oxygen). Constant temperature isothermal solidification of the new interfacial gas-metal eutectic composition liquid 20 (copper-nickel-oxygen) occurs to form an interlayer of a solid metal alloy or other metallically bonded material by the transient liquid phase process as shown in FIG. 4. Diffusional homogenization (blending of unlike elements) further increases the solidus temperature of the solid metallic interlayer portion 24 of the joint 30.

An extended hold at the bond temperature or other elevated temperature causes interdiffusion of the active metal component layer 12 and the solid metallic interlayer 24, which results in a strong component layer 28 of metal alloy or other metallically bonded material, (a copper-nickel alloy in the illustrated system), that is bonded to the ceramic component layer 10 by a thin (micron-thick) interfacial compound formed by reaction layers 22 and 26. The interfacial metals of the reaction layers 22 and 26 may fully homogenize with the metallic component layer 28 (with a sufficient hold at elevated temperature thereby eliminating the metal-metal interface. Because the low-melting, liquid metal (copper in the illustrated system) of layer 20 incorporates the more refractory metal from the metallic component layer 12 to form the metal alloy layer 28, the resulting bond or joint 30 has a melting point significantly higher than the temperature at which the bond or joint 30 was formed. The thickness and composition of reaction layers 22 and 26 may be further modified by changing the oxygen fugacity during the extended hold at elevated temperature.

The method of the present invention was evaluated using the illustrative nickel/copper-oxygen/alumina system. Multilayer bond structures were produced using both foils and plating. Oxygen additions were investigated using pre-oxidation of each metal and/or oxidation in-situ. The best bonds resulted from foils combining nickel pre-oxidation with a eutectic atmosphere. Adhesion was comparable to current technologies with a peel test strength of about 50 N/cm as compared to about 35 N/cm for nickel foil bonded by the direct bond copper method. The bond can exceed the ceramic strength as shown by occasional peel test failures in the ceramic rather than the bond interfaces. Typical peel failure occurred at the metal (the nickel/copper-nickel) interface. Residual thermo-elastic stress is reduced relative to conventional direct bond copper. A high-temperature peel test was developed to evaluate thermal stability. It showed that strength was maintained to 800° C., the apparatus limit. Long term exposure at 1000° C. did not deteriorate bond strength when interfacial oxidation was limited.

The direct bond method of the present invention increases flexibility in processing temperature and atmosphere, reduces residual bond stresses, and significantly improves high temperature corrosion and mechanical properties at a reduced processing cost. Large parts, rough surfaces, and complex geometries can be accommodated in the method of the present invention.

The method of the present invention may also be employed to produce metal matrix composites (MMC's) containing ceramic particles (cermets), fibers, fibrous structures (weaves and preforms) or combinations thereof. Similarly, it may be used to produce ceramic matrix composites. In order to fabricate a microscopic or macroscopic composite structure or material, metallic (such as nickel) particles, fibers, fibrous structures or combinations thereof are coated with a less refractory metallic interlayer (such as copper), thereby forming multilayer particles, fibers, or fibrous structures. The active metal particles, fibers, or fibrous structures may first be oxidized or otherwise coated with a barrier layer (such as nickel oxide) to prevent premature interaction between the interlayer and the active metal. These particles, fibers, or fibrous structures are then mixed with or infiltrated into the ceramic powder or preform. Alternately, an active metal preform or weave may be coated with a less refractory metal and infiltrated with ceramic. As in the case of the multilayer structure described above, by adding a eutectic forming reactant, such a gas, to the metallic interlayer; and heating the structure to approximately a eutectic melting temperature of the reactant and the interlayer, a eutectic gas-metal (in the case of a gas reactant) liquid may be formed. This eutectic liquid interacts with the ceramic component particles, fibers, or fibrous structure and the metallic component particles, fibers or fibrous structures to form a bond that directly joins the ceramic and metal composite particles, fibers, or fibrous structures to one another. The eutectic liquid to subsequently transforms to solid by the transient liquid phase method described above. The bond structure and further treatments are as described in the multilayer structure above, but possess a three-dimensional composite arrangement at microscopic and/or macroscopic scales.

While the foregoing invention has been described with reference to the above embodiments, various modifications and changes can be made without departing from the spirit of the invention. Accordingly, all such modifications and changes are considered to be within the scope of the appended claims.

1. A method for directly joining ceramics and metals, the method comprising:
forming a structure having a ceramic component, a metallic component and a metallic interlayer disposed between the ceramic component and the metal metallic component, the metallic interlayer being less refractory than the metallic component;
adding a eutectic liquid forming reactant to the metallic interlayer; and
heating the structure to approximately a eutectic melting temperature of the reactant and the interlayer to form metallic-material-based eutectic liquid that interacts with the ceramic component and the metallic component to form a bond that directly joins the ceramic and metallic components to one another.

2. The method according to claim 1, wherein the structure further includes a barrier layer that controls the interaction between the metallic interlayer and the metallic component.

3. The method according to claim 1, wherein the adding step is performed prior to the heating step.

4. The method according to claim 1, wherein the adding step is performed substantially concurrent with the heating step.

5. The method according to claim 1, wherein the reactant comprises a gas.

6. The method according to claim 5, wherein the gas comprises oxygen.

7. The method according to claim 1, wherein the metallic interlayer comprises copper.

8. The method according to claim 1, wherein the ceramic component comprises alumina.

9. The method according to claim 1, wherein the metallic component comprises nickel.

10. The method according to claim 1, wherein the reactant comprises oxygen, the metallic interlayer comprises copper, the ceramic component comprises alumina, and the metallic component comprises nickel.

11. The method according to claim 1, wherein the ceramic component is selected from the group consisting of a ceramic layer, ceramic particles, ceramic fibers, ceramic fibrous structures, and combinations thereof; the metallic component is selected from the group consisting of a metal layer, a metal alloy layer, an intermetallic layer, metal particles, metal alloy particles, intermetallic particles, metal fibers, metal alloy fibers, intermetallic fibers, metal fibrous structures, metal alloy fibrous structures, intermetallic fibrous structures and combinations thereof; and the metallic interlayer is selected from the group consisting of a metal, a metal alloy, an intermetallic, and combinations thereof.

12. A method for directly joining ceramics and metals, the method comprising:
forming a structure having a ceramic component and a metallic component; and
reacting a metallic-material-based eutectic liquid with the metallic component, which is more active than the eutectic liquid, such that active metal specie diffuse to the ceramic component thereby enhancing bonding between the ceramic component and the metallic component.

13. The method according to claim 12, wherein the ceramic component is selected from the group consisting of a ceramic layer, ceramic particles, ceramic fibers, ceramic fibrous structures, and combinations thereof; the metallic component is selected from the group consisting of a metal layer, a metal alloy layer, an intermetallic layer, metal particles, metal alloy particles, intermetallic particles, metal fibers, metal alloy fibers, intermetallic fibers, metal fibrous structures, metal alloy fibrous structures, intermetallic fibrous structures and combinations thereof; and the metallic-material-based eutectic liquid is selected from the group consisting of a metal, a metal alloy, an intermetallic, and combinations thereof.

14. A method for directly joining ceramics and metals, the method comprising:
forming a structure having a ceramic component and a metallic component; and
reacting a metallic-material-based eutectic liquid with the metallic component, which is more refractory than the eutectic liquid, to form a liquid composition that solidifies isothermally as a transient liquid phase joining the ceramic component and the metal component to one another.

15. The method according to claim 14, wherein the ceramic component is selected from the group consisting of a ceramic layer, ceramic particles, ceramic fibers, ceramic fibrous structures, and combinations thereof; the metallic component is selected from the group consisting of a metal layer, a metal alloy layer, an intermetallic layer, metal particles, metal alloy particles, intermetallic particles, metal fibers, metal alloy fibers, intermetallic fibers, metal fibrous structures, metal alloy fibrous structures, intermetallic fibrous structures and combinations thereof; and the metallic-material-based eutectic liquid is selected from the group consisting of a metal, a metal alloy, an intermetallic, and combinations thereof.

16. A method for directly joining ceramics and metals, the method comprising:
forming a structure having a ceramic component and a metallic component;
reacting the metallic component with a metallic-material-based eutectic liquid that transitions into a transient liquid phase that solidifies; and
further reacting the solidified transient liquid phase with the metallic component, which is more refractory than the metallic component, at elevated temperature to form a solid metallic composition with a melting point that is greater than the solidified transient liquid phase.

17. The method according to claim 16, wherein the ceramic component is selected from the group consisting of a ceramic layer, ceramic particles, ceramic fibers, ceramic fibrous structures, and combinations thereof; the metallic component is selected from the group consisting of a metal layer, a metal alloy layer, an intermetallic layer, metal particles, metal alloy particles, intermetallic particles, metal fibers, metal alloy fibers, intermetallic fibers, metal fibrous structures, metal alloy fibrous structures, intermetallic fibrous structures and combinations thereof; and the metallic-material-based eutectic liquid is selected from the group consisting of a metal, a metal alloy, an intermetallic, and combinations thereof.

18. A method for directly joining ceramics and metals, the method comprising:
forming a structure having a ceramic component and a metallic component;
providing a metallic-material-based eutectic liquid that transitions into a transient liquid phase that solidifies; and
reacting the solidified transient liquid phase with the metallic component, which is more refractory than the solidified transient liquid phase, at an elevated temperature to form a homogeneous metallically bonded material.

19. The method according to claim 16, wherein the ceramic component is selected from the group consisting of a ceramic layer, ceramic particles, ceramic fibers, ceramic fibrous structures, and combinations thereof; the metallic component is selected from the group consisting of a metal layer, a metal alloy layer, an intermetallic layer, metal particles, metal alloy particles, intermetallic particles, metal fibers, metal alloy fibers, intermetallic fibers, metal fibrous structures, metal alloy fibrous structures, intermetallic fibrous structures and combinations thereof; and the metallic-material-based eutectic liquid is selected from the group consisting of a metal, a metal alloy, an intermetallic, and combinations thereof.

20. A method of fabricating a composite structure or material, the method comprising:
providing a ceramic component selected from the group consisting of ceramic particles, ceramic fibers, and ceramic fibrous structures and combinations thereof;
providing a metallic component selected from the group consisting of metal particles, metal alloy particles, intermetallic particles, metal fibers, metal alloy fibers, intermetallic fibers, metal fibrous structures, metal alloy fibrous structures, intermetallic fibrous structures, and combinations thereof, the metallic component coated with a less refractory metallic interlayer selected from the group consisting of a metal, a metal alloy, an intermetallic, and combinations thereof;
mixing the ceramic component with the metallic component, the metallic interlayer being disposed between the ceramic component and the metallic component;
adding a eutectic liquid forming reactant to the metallic interlayer; and
heating the structure to approximately a eutectic melting temperature of the reactant and the metallic interlayer to form a metallic-material-based eutectic liquid that interacts with the ceramic component and the metallic component to form a bond that directly joins the ceramic component and metallic component to one another.

21. The method according to claim 20, wherein the eutectic liquid transitions into a transient liquid phase that solidifies; and
reacting the solidified transient liquid phase with the metallic component, which is more refractory than the solidified transient liquid phase, at an elevated temperature to form a homogeneous metallically bonded material better.
